(19) United States
(12) Patent Application Publication
(10) Pub. No.: US 2010/0232300 A1
(43) Pub. Date: Sep. 16, 2010

(54) ROUTING CONTROL DEVICE, ROUTING CONTROL METHOD, AND STORAGE MEDIUM STORING ROUTING CONTROL PROGRAM

(75) Inventor: Hiroaki KASHIMA, Kawasaki-shi (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/721,059

(22) Filed: Mar. 10, 2010

(30) Foreign Application Priority Data
Mar. 11, 2009 (JP) 2009-057597

(51) Int. Cl. H04L 12/26

(52) U.S. Cl. 370/242

(57) ABSTRACT

A routing control device includes a plurality of communication interfaces and a processing unit. The processing unit determines whether each of the plurality of communication interfaces has a fault, sets, in routing control information to perform an advertisement, an address of a communication interface of the plurality of communication interfaces that is determined as having a fault and an address of a subnet connected to a communication interface of the plurality of communication interfaces that is determined as not having a fault.

### CROSS-REFERENCE TO RELATED APPLICATIONS

This application is based upon and claims the benefit of priority of the prior Japanese Patent Application No. 2009-57597, filed on Mar. 11, 2009, the entire contents of which are incorporated herein by reference.

### FIELD

Embodiments described herein relate to a routing control device, a routing control method, and a storage medium storing a routing control program.

### BACKGROUND

A giant network, for example, the Internet is typically managed by the use of small networks, which are called subnets, into which the network is divided.

A subnet is a small network that is a unit of management of a giant network using smaller networks into which the giant network is divided. One example of the subnet is an address group assigned to a local area network (LAN).

A network administrator selects and sets a single unique address for a device connected to a subnet from an address group such that the single unique address is not identical with the addresses of the other devices. FIG. 1 is an illustration for use in describing addresses of devices connected to a subnet. The address of the subnet illustrated in FIG. 1 is “192.X.1.0/24.”

The subnet address “192.X.1.0/24” indicates that an address group assigned to the subnet is from “192.X.1.1” to “192.X.1.254.”

The subnet illustrated in FIG. 1 is connected to devices A to C. The devices A to C have the uniquely set addresses “192.X.1.1,” “192.X.1.2,” and “192.X.1.3,” respectively.

Subnets are interconnected through a routing control device, such as a router. Here, a router is described by way of example. A router is a device for interconnecting subnets and includes an interface (e.g., communication interface) for connecting to subnets.

FIG. 2 is an illustration for use in describing addresses set in a plurality of interfaces included in a router. A router ‘A’ illustrated in FIG. 2 interconnects a subnet having the address “192.X.1.0/24” and a subnet having the address “192.X.2.0/24.”

The router A includes an interface having the address “192.X.1.1” for connecting to the subnet having the address “192.X.1.0/24.” The router A also includes an interface having the address “192.X.2.1” for connecting to the subnet having the address “192.X.2.0/24.”

For example, the router A illustrated in FIG. 2 notifies adjacent routers (not shown) that it can communicate with a neighboring device connected to the subnets having the addresses “192.X.1.0/24” and “192.X.2.0/24” connected to the router A by advertisement of subnet information serving as routing control information.

At the same time, the router A illustrated in FIG. 2 learns that it can also communicate with a device on a non-neighboring remote subnet by being notified of advertisement of subnet information published by adjacent routers and remote routers (not depicted).

Some routers have an assigned loopback address being an address on a virtual subnet in preparation for a fault occurring in an interface. A traditional router that has an assigned loopback address enables interconnection between routers to continue using the loopback address even if a fault occurs in part of interfaces by having notifying neighboring routers of the loopback address.

Some routing control devices send a route confirmation notice to a destination node when a fault occurs in an interface in order to allow accurate routing information to be distributed on a network without broadcasting routing information at regular intervals.

### SUMMARY

According to an aspect of the invention, a routing control device includes: a plurality of communication interfaces and a processing unit. The processing unit determines whether each of the plurality of communication interfaces has a fault, sets, in routing control information to perform advertisement, an address of a communication interface of the plurality of communication interfaces that determined as having a fault and an address of a subnet connected to a communication interface of the plurality of communication interfaces that determined as having no fault.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an illustration for use in describing addresses of devices connected to a subnet;

FIG. 2 is an illustration for use in describing addresses set in interfaces included in a router;

FIG. 3 is an illustration for use in describing advertisement of subnet information;

FIG. 4 illustrates a configuration of one example of a router;

FIG. 5A illustrates a configuration of one example of a routing table managed by a route management unit of a router A;

FIG. 5B illustrates a configuration of one example of a routing table managed by a route management unit of a router B;

FIG. 6A is a conceptual diagram illustrating a state in which advertisement is published in the case where the router A interconnects with the remote router B;

FIG. 6B is a conceptual diagram illustrating a state in which advertisement is reached in the case where the router A interconnects with the remote router B;

FIG. 6C is a conceptual diagram illustrating a state after advertisement published when the router A interconnects with the remote router B is reached;

FIG. 7A is a conceptual diagram illustrating the routing table of the router A at a point in time;

FIG. 7B is a conceptual diagram illustrating information on advertisement of subnet information generated by the router A on the basis of the routing table of FIG. 7A;

FIG. 7C is a conceptual diagram illustrating the routing table of the router B based on the advertisement of FIG. 7B;

FIG. 7D is a conceptual diagram illustrating a BGP setting of the router B based on the routing table of FIG. 7C;

FIG. 8A is a conceptual diagram illustrating the routing table of router A when advertisement of subnet information published by the router A is propagated to the router B using RIP;

FIG. 8B is a conceptual diagram illustrating advertisement of subnet information generated by the router A on the basis of the routing table of FIG. 8A;

FIG. 8C is a conceptual diagram illustrating advertisement of subnet information that reaches the router B on the basis of the advertisement of FIG. 8B;

FIG. 8D is a conceptual diagram illustrating the routing table of the router B based on the advertisement of FIG. 8C;

FIG. 8E is a conceptual diagram illustrating the BGP setting of the router B based on the routing table of FIG. 8D;

FIG. 9A is a first conceptual diagram illustrating a state where an interface of the router A becomes abnormal after the interconnection between the routers A and B is established;

FIG. 9B is a second conceptual diagram illustrating a state where the interface of the router A becomes abnormal after interconnection between the routers A and B is established;

FIG. 10A is a conceptual diagram illustrating the routing table of the router A when an interface of the router A shifts from a normal state to an abnormal state;

FIG. 10B is a conceptual diagram illustrating advertisement of subnet information generated by the router A on the basis of the routing table of FIG. 10A;

FIG. 10C is a conceptual diagram illustrating advertisement of subnet information that reaches the router B on the basis of the advertisement of FIG. 10B;

FIG. 10D is a conceptual diagram illustrating the routing table of the router B based on the advertisement of FIG. 10C;

FIG. 10E is a conceptual diagram illustrating the BGP setting of the router B based on the routing table of FIG. 10D;

FIG. 11 is a conceptual diagram illustrating how the router A interconnects with the remote router B by using a loopback interface;

FIG. 12 illustrates a configuration of one example of a router using a loopback interface.

FIG. 13A is a conceptual diagram illustrating the routing table of the router A when an interface of the router A is in a normal state;

FIG. 13B is a conceptual diagram illustrating advertisement of subnet information generated by the router A on the basis of the routing table of FIG. 13A;

FIG. 13C is a conceptual diagram illustrating advertisement of subnet information that reaches the router B on the basis of the advertisement of FIG. 13B;

FIG. 13D is a conceptual diagram illustrating the routing table of the router B based on the advertisement of FIG. 13C;

FIG. 13E is a conceptual diagram illustrating the BGP setting of the router B based on the routing table of FIG. 13D;

FIG. 14A is a conceptual diagram illustrating the routing table of the router A when an interface of the router A shifts from a normal state to an abnormal state;

FIG. 14B is a conceptual diagram illustrating advertisement of subnet information generated by the router A on the basis of a change in the routing table of FIG. 14A;

FIG. 14C is a conceptual diagram illustrating advertisement of subnet information that reaches the router B on the basis of the advertisement of FIG. 14B;

FIG. 14D is a conceptual diagram illustrating the routing table of the router B based on the advertisement of FIG. 14C;

FIG. 14E is a conceptual diagram illustrating the BGP setting of the router B based on the routing table of FIG. 14D;

FIG. 15 illustrates one example of a table for use in managing subnets by a network administrator;

FIG. 16A is a first conceptual diagram illustrating a state where an interface of the router A becomes abnormal after interconnection between the routers A and B is established according to the present embodiment;

FIG. 16B is a second conceptual diagram illustrating a state where the interface of the router A becomes abnormal after the interconnection between the routers A and B is established according to the present embodiment;

FIG. 17 illustrates a configuration of one example of a router according to the present embodiment;

FIG. 18A is a conceptual diagram illustrating the routing table of the router A when an interface of the router A is in a normal state;

FIG. 18B is a conceptual diagram illustrating advertisement of subnet information generated by the router A on the basis of the routing table of FIG. 18A;

FIG. 18C is a conceptual diagram illustrating advertisement of subnet information that reaches the router B on the basis of the advertisement of FIG. 18B;

FIG. 18D is a conceptual diagram illustrating the routing table of the router B based on the advertisement of FIG. 18C;

FIG. 18E is a conceptual diagram illustrating the BGP setting of the router B based on the routing table of FIG. 18D;

FIG. 19A is a conceptual diagram illustrating the routing table of the router A when an interface of the router A shifts from a normal state to an abnormal state;

FIG. 19B is a conceptual diagram illustrating advertisement of subnet information generated by the router A on the basis of a change in the routing table of FIG. 19A;

FIG. 19C is a conceptual diagram illustrating advertisement of subnet information that reaches the router B on the basis of the advertisement of FIG. 19B;

FIG. 19D is a conceptual diagram illustrating the routing table of the router B based on the advertisement of FIG. 19C;

FIG. 19E is a conceptual diagram illustrating the BGP setting of the router B based on the routing table of FIG. 19D;

FIG. 20 illustrates a system configuration for use in describing eBGP and iBGP.

FIG. 21 illustrates a hardware configuration of a router.

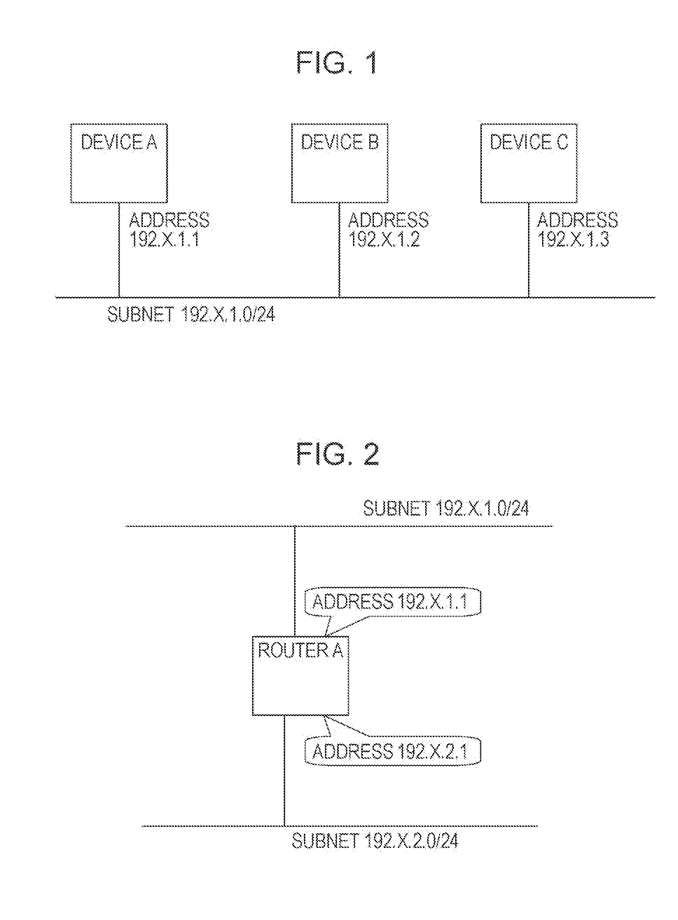

### DESCRIPTION OF EMBODIMENTS

Best mode for carrying out the invention is described with reference to the drawings on the basis of an embodiment below. The present embodiment is described using a router being one example of a routing control device by way of example. However, any routing control device may be used.

In the following, for facilitating understanding of the present embodiment, issues and/or problems of a traditional router will be described in detail, and then the details of the present embodiment are described.

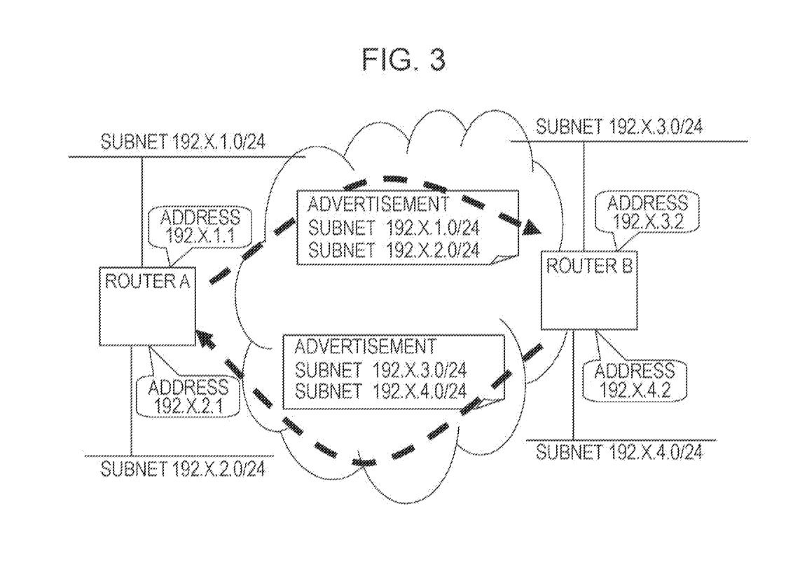

FIG. 3 is an illustration for use in describing advertisement of subnet information.

A router ‘A’ illustrated in FIG. 3 notifies adjacent routers, including a router B, that it can communicate with a neighboring device connected to the subnets having the addresses “192.X.1.0/24” and “192.X.2.0/24” connected to the router A by advertisement of subnet information serving as routing control information. Further, the router A learns that it can also communicate with a device on a non-neighboring remote subnet by being notified of an advertisement of subnet information published by the adjacent router including the router B or remote routers.

The router B illustrated in FIG. 3 notifies adjacent routers, including the router A, that it can communicate with a neighboring device connected to the subnets having the addresses “192.X.3.0/24” and “192.X.4.0/24” connected to the router B by advertisement of subnet information serving as routing control information. Further, the router B learns that it can also communicate with a device on a non-neighboring remote subnet by being notified of an advertisement of subnet information published by the adjacent routers including the router A and remote routers.

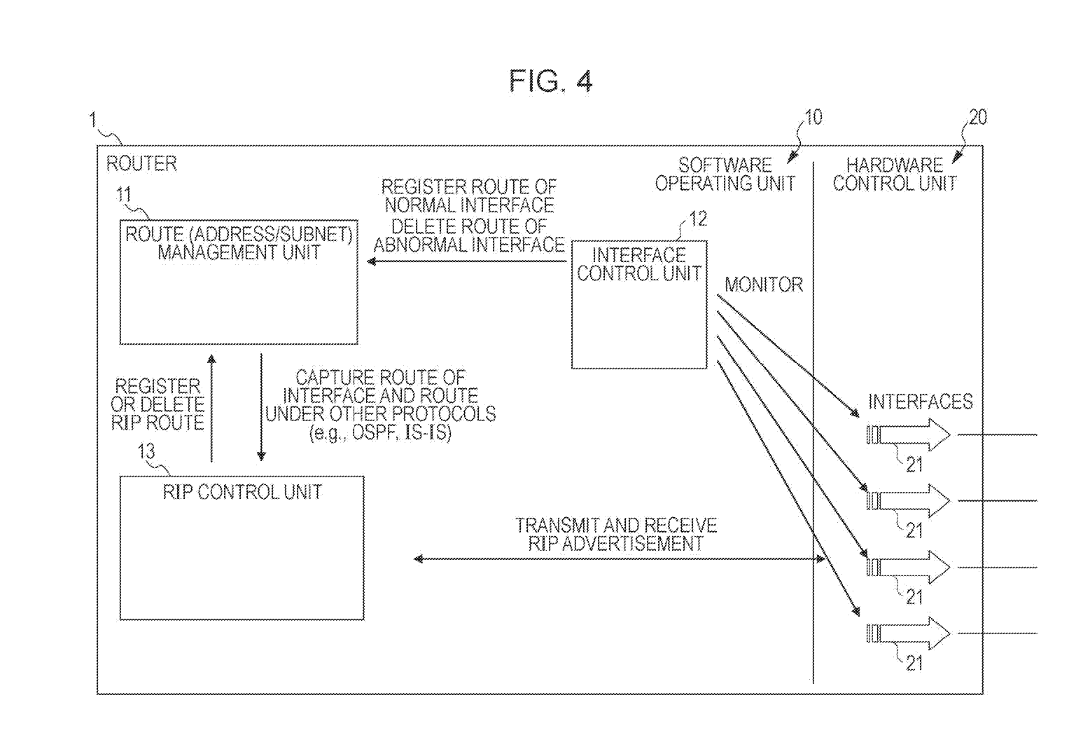

FIG. 4 illustrates a configuration of one example of a router. A router 1 illustrated in FIG. 4 has a configuration that includes a software operating unit 10 and a hardware control unit 20. The router 1 illustrated in FIG. 4 is described as being an example that uses the routing information protocol (RIP) RFC 2453 and RFC 2080 as a protocol for use in exchanging advertisements of subnet information. However, other protocols, such as open shortest path first (OSPF) RFC 2328, RFC 2740, border gateway protocol (BGP) RFC 4271, and intermediate system to intermediate system (IS-IS), may also be used.

The software operating unit 10 has a configuration that includes a route management unit 11, an interface control unit 12, and a RIP control unit 13. The hardware control unit 20 has a configuration that includes a plurality of interfaces 21.

The route management unit 11 manages route addresses/subnets using a routing table described below. The interface control unit 12 monitors normality and abnormality of the interfaces 21 included in the hardware control unit 20.

The interface control unit 12 requests the route management unit 11 to register the route of an interface being in a normal state (normal interface) of the interfaces 21. Also, the interface control unit 12 requests the route management unit 11 to delete the route of an interface being in an abnormal state (abnormal interface) of the interfaces 21. In response to the request from the interface control unit 12, the route management unit 11 registers the route of the normal interface 21 in the routing table, which is described below, or deletes the route of the abnormal interface from the routing table.

The RIP control unit 13 transmits and receives advertisements of subnet information through an interface 21 using the RIP. The RIP control unit 13 captures the route of the interface 21 and a route under other protocols, such as OSPF or IS-IS, from the route management unit 11 and notifies adjacent routers that the router 1 can communicate with a neighboring device on a subnet connected to the router 1 by advertisement of the subnet information.

The RIP control unit 13 is notified of advertisements of subnet information published by adjacent routers and remote routers through an interface 21. The RIP control unit 13 requests the route management unit 11 to register the route of a non-neighboring remote subnet on the basis of the advertisement of subnet information received. Also, the RIP control unit 13 requests the route management unit 11 to delete the route of a non-neighboring remote subnet on the basis of a received deletion advertisement of subnet information.

In response to the request from the RIP control unit 13, the route management unit 11 registers the route of the non-neighboring remote subnet in the routing table, which is described below, or deletes the route of the non-neighboring remote subnet from the routing table.

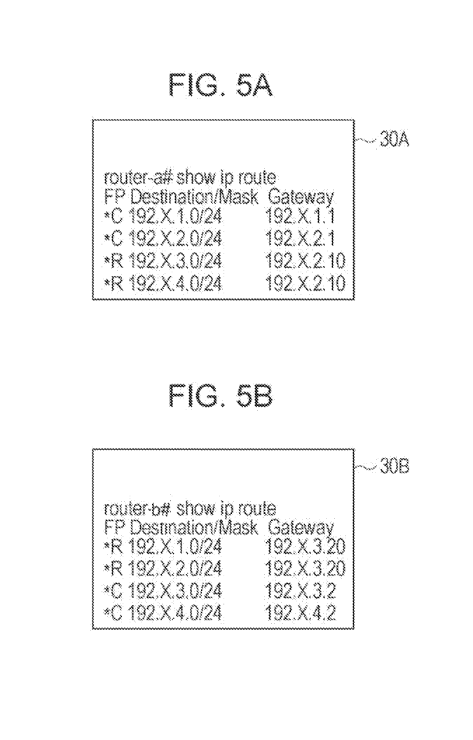

FIGS. 5A and 5B illustrate configurations of one example of a routing table managed by the route management unit. Specifically, FIG. 5A illustrates a routing table 30A managed by the route management unit of the router A, and FIG. 5B illustrates a routing table 30B managed by the route management unit of the router B. In the routing table 30A illustrated in FIG. 5A, the two upper routes indicate the routes of the interfaces 21 of the router A. In the routing table 30A, the two lower routes indicate the routes of remote subnets that are not next to the router A, the routes being registered on the basis of an advertisement of subnet information.

In the routing table 30B illustrated in FIG. 5B, the two upper routes indicate the routes of remote subnets that are not next to the router B, the routes being registered on the basis of an advertisement of subnet information. In the routing table 30B, the two lower routes indicate the routes of the interfaces 21 of the router B.

It is to be noted that, in reality, neighboring routers of the router A and those of the router B also have other subnets and advertisements of subnet information for the other subnets are provided in most cases. However, the other subnets and advertisements are omitted herein for the sake of brevity. In the routing table 30A of FIG. 5A and the routing table 30B of FIG. 5B, the routes of the interfaces 21 of the routers A and B and the routes of the non-neighboring remote subnets are represented by the addresses of the subnets and the addresses of the interfaces 21.

In the routing table 30A of FIG. 5A and the routing table 30B of FIG. 5B, each of the routes of remote subnets that are not next to the router A and each of the routes of the remote subnets that are not next to the router B is represented by the address of an interface of a neighboring router that relays the advertisement of subnet information.

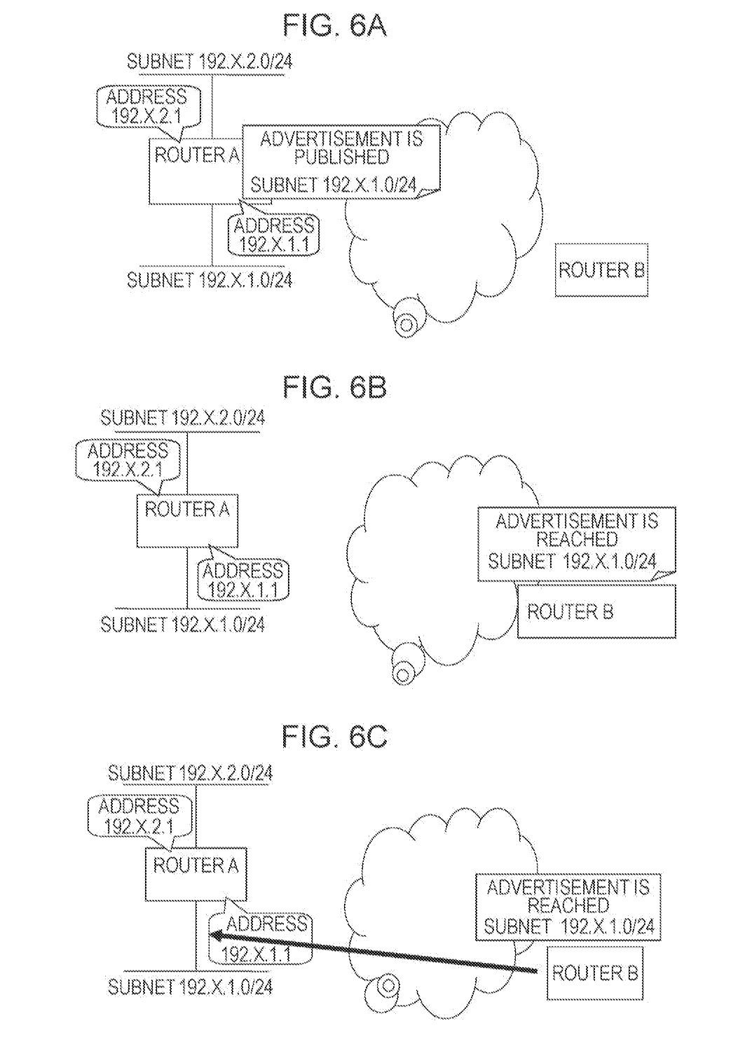

FIGS. 6A to 6C are conceptual diagrams illustrating how the router A interconnects with the remote router B. For example, in the case where the router A interconnects with the remote router B using the border gateway protocol (BGP) or tunneling, the address “192.X.1.1” of the interface 21, among the plurality of interfaces 21 of the router A, connected to the subnet having the address “192.X.1.0/24” is written in a setting of the router B, for example, the BGP setting.

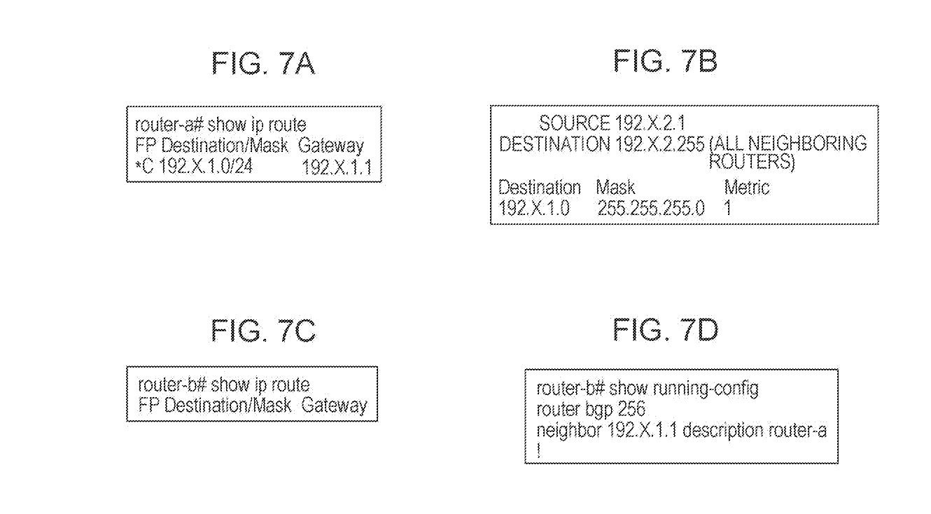

FIG. 6A illustrates a state where the router A publishes an advertisement of subnet information. The routing table of the router A at this time is illustrated in FIG. 7A, an advertisement of subnet information generated by the router A is illustrated in FIG. 7B, the routing table of the router B based on that advertisement is illustrated in FIG. 7C, and the BGP setting of the router B based on that routing table of FIG. 7C is illustrated in FIG. 7D.

It is to be noted that the routers A and B have other interfaces 21 for use in connecting to a network, in addition to the interface 21 having the address “192.X.1.1” and the interface 21 having the address “192.X.2.1,” which are illustrated in FIGS. 6A to 6C, however, these other interfaces are omitted for the sake of brevity. Similarly, the routing table of the router A illustrated in FIG. 7A, the advertisement of subnet information generated by the router A illustrated in FIG. 7B, the routing table of the router B illustrated in FIG. 7C, and the BGP setting illustrated in FIG. 7D are described based on the addresses of the subnets and the interfaces 21 illustrated in FIGS. 6A to 6C.

FIG. 7A illustrates the routing table of the router A at a point in time. Because the interface 21 having the address “192.X.1.1” is in a normal state, the subnet having the address “192.X.1.0/24” is visible in the routing table of FIG. 7A. The subnet having the address “192.X.2.0/24” is omitted.

FIG. 7B illustrates an advertisement of subnet information generated by the router A on the basis of the routing table of FIG. 7A. The advertisement of subnet information illustrated in FIG. 7B is distributed from the interface 21 having the address “192.X.2.1” to all neighboring routers.

FIG. 7C illustrates the routing table of the router B based on the advertisement illustrated in FIG. 7B.

FIG. 7D illustrates the BGP setting of the router B based on the routing table of FIG. 7C. In the BGP setting illustrated in FIG. 7D, the address “192.X.1.1” of the interface 21 connected to the subnet having the address “192.X.1.0/24” among the plurality of interfaces 21 of the router A is written.

FIG. 6B illustrates a state where the advertisement of subnet information published by the router A is propagated to the router B using the RIP.

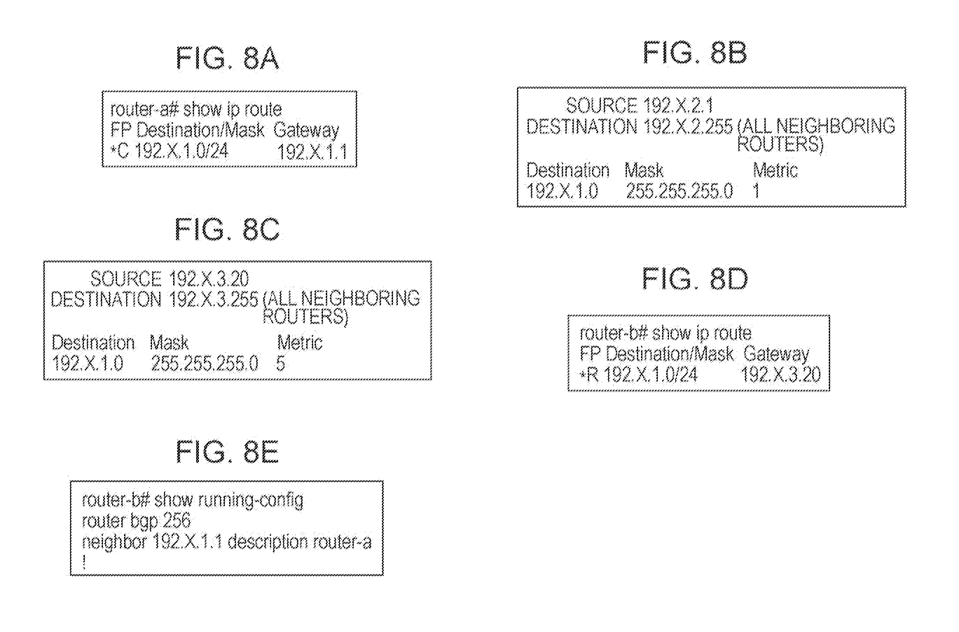

The routing table of the router A at this time is illustrated in FIG. 8A, an advertisement of subnet information generated by the router A is illustrated in FIG. 8B, an advertisement of subnet information that reaches the router B is illustrated in FIG. 8C, the routing table of the router B is illustrated in FIG. 8D, and the BGP setting of the router B is illustrated in FIG. 8D.

FIG. 8A is the same as FIG. 7A, and FIG. 8B is the same as FIG. 7B, so the description thereof is omitted.

FIG. 8C illustrates an advertisement of subnet information that reaches the router B on the basis of the advertisement of FIG. 8B. Because the advertisement of subnet information has passed through several routers within a network, the source, destination, and metric in FIG. 8C are changed from those in FIG. 8B.

FIG. 8D illustrates the routing table of the router B based on the advertisement of subnet information illustrated in FIG. 8C when the advertisement of subnet information published by the router A illustrated in FIG. 8B is propagated to the router B. In response to the advertisement of the subnet information illustrated in FIG. 8C, the subnet having the address “192.X.1.0/24” is added in the routing table of the router B.

The BGP setting of the router B illustrated in FIG. 8E is the same as that illustrated in FIG. 7D. The router B determines that the addition of the subnet having the address “192.X.1.0/24” in the routing table illustrated in FIG. 8D enables information to reach the address “192.X.1.1” and starts BGP communication to attempt to connect to the address “192.X.1.1” of the interface 21 of the router A.

FIG. 6C illustrates a state where the router B attempts to connect to the address of the interface of the router A after the advertisement of subnet information published by the router A is propagated to the router B using the RIP. When the attempt of the connection illustrated in FIG. 6C is successful, the routers A and B are interconnected.

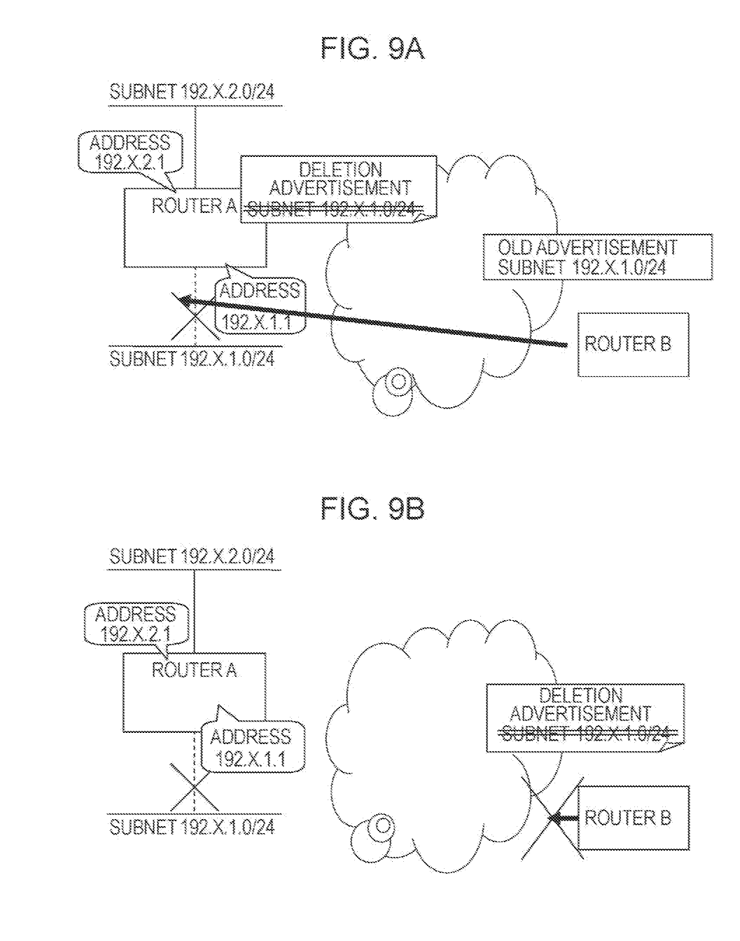

FIGS. 9A and 9B are conceptual diagrams illustrating states where an interface of the router A becomes abnormal after the interconnection between the routers A and B is established. FIG. 9A illustrates a state where the router A publishes a deletion advertisement of subnet information because the interface of the router A becomes abnormal and the interconnection between the routers A and B is disabled.

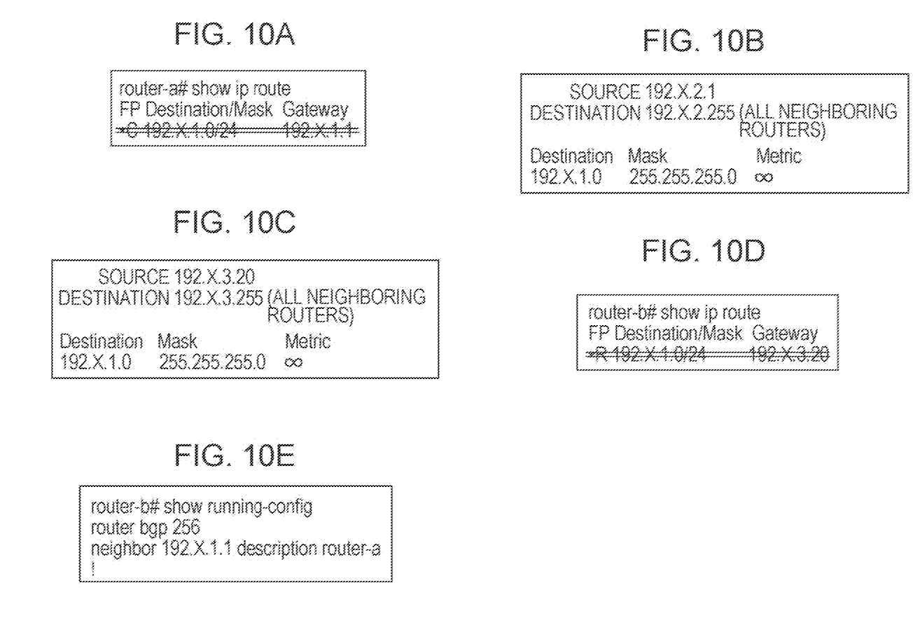

When the interface 21 having the address “192.X.1.1” shifts from a normal state to an abnormal state, the router A publishes a deletion advertisement of subnet information to delete the subnet having the address “192.X.1.0/24.” The routing table of the router A at this time is illustrated in FIG. 10A, the deletion advertisement of subnet information generated by the router A is illustrated in FIG. 10B, the deletion advertisement of subnet information that reaches the router B is illustrated in FIG. 10C, the routing table of the router B is illustrated in FIG. 10D, and the BGP setting of the router B is illustrated in FIG. 10E.

FIG. 10A illustrates the routing table of the router A when the interface 21 having the address “192.X.1.1” of the router A shifts from a normal state to an abnormal state, as illustrated in FIG. 9A. In the routing table illustrated in FIG. 10A, because the interface 21 having the address “192.X.1.1” shifts from a normal state to an abnormal state, the subnet having the address “192.X.1.0/24” is invisible, which is shown by the double-strikethrough in FIG. 10A. It is noted that double-strikethrough is used through-out the drawings to represent information that is invisible.

FIG. 10B illustrates the deletion advertisement of subnet information generated by the router A on the basis of a change in the routing table illustrated in FIG. 10A. The deletion advertisement of subnet information illustrated in FIG. 10B is generated based on a route that was stored in the routing table illustrated in FIG. 10A but is made invisible because of the abnormal state. The deletion advertisement of subnet information illustrated in FIG. 10B is distributed from the interface 21 having the address “192.X.2.1” to all neighboring routers.

FIG. 9B illustrates a state where the deletion advertisement of subnet information published by the router A is propagated to the router B using the RIP.

FIG. 10C illustrates the deletion advertisement of subnet information that reaches the router B. Because the deletion advertisement of subnet information has passed through several routers within a network, the source and destination are changed from those in FIG. 10B.

FIG. 10D illustrates the routing table of the router B based on the deletion advertisement of subnet information illustrated in FIG. 10C when the deletion advertisement of subnet information published by the router A illustrated in FIG. 10B is propagated to the router B. In response to the deletion advertisement of subnet information illustrated in FIG. 10C, the subnet having the address “192.X.1.0/24” is deleted from the routing table of the router B.

The BGP setting of the router B illustrated in FIG. 10E is the same as that illustrated in FIG. 8E. The router B determines that the deletion of the subnet having the address “192.X.1.0/24” from the routing table illustrated in FIG. 10D disables information from reaching the address “192.X.1.1” and stops BGP communication to disconnect the address “192.X.1.1” of the interface 21 of the router A.

FIG. 9B also illustrates a state where the interconnection between the routers A and B is disabled after the deletion advertisement of subnet information published by the router A is propagated to the router B.

Incidentally, the router A includes the plurality of interfaces 21. The router A has addresses differing from one interface 21 to another. Ordinarily, even if one interface 21 becomes abnormal, the router A enables information to reach its destination by attempting to connect to another interface 21.

However, the interface 21 of the router A set in the router B is the interface having the address “192.X.1.1” connected to the subnet having the address “192.X.1.0/24.” Accordingly, if the subnet having the address “192.X.1.0/24” is deleted from the routing table of the router B, a problem arises in that interconnection between the routers A and B is disabled.

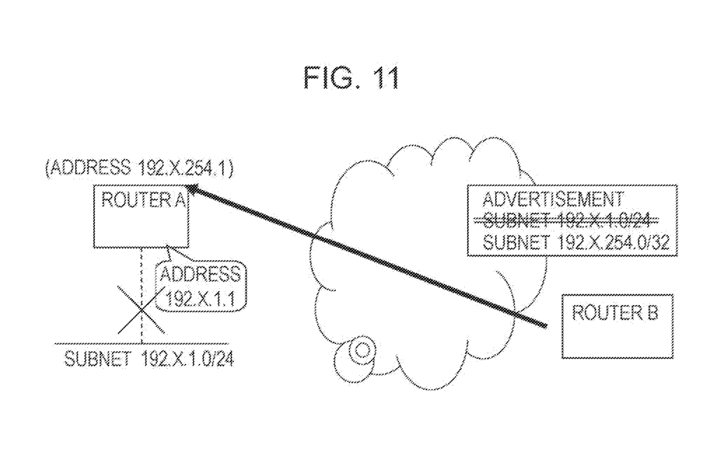

A typical current solution to the problem illustrated in FIGS. 9 and 10 is the use of a “loopback interface.” FIG. 11 is a conceptual diagram illustrating a state where the router A interconnects with the remote router B using the loopback interface.

A loopback interface exists in only the setting and aims to look as if it was connected to a nonexistent subnet. Because the loopback interface aims to look as if it was connected to a nonexistent subnet, the loopback interface is free from fault and is always in a normal state. Accordingly, when the router A interconnects with the router B using the loopback interface, no deletion advertisement of subnet information is published.

In FIG. 11, the loopback interface is additionally defined in the router A, and the address “192.X.254.1” of the nonexistent subnet having the address “192.X.254.0/32” is assigned to the loopback interface. In the BGP setting of the remote router B, the address “192.X.254.1” of the interface 21 connected to the subnet having the address “192.X.254.0/32” is set.

Even if part of the interfaces 21 of the router A deviates from a normal state, the router A can always continue to publish advertisement of subnet information on the subnet having the address “192.X.254.0/32.” Accordingly, even if part of the interfaces 21 of the router A deviates from a normal state, the remote router B can continue to interconnect with the router A because the router B can communicate with the address “192.X.254.1” of the interface of the router A.

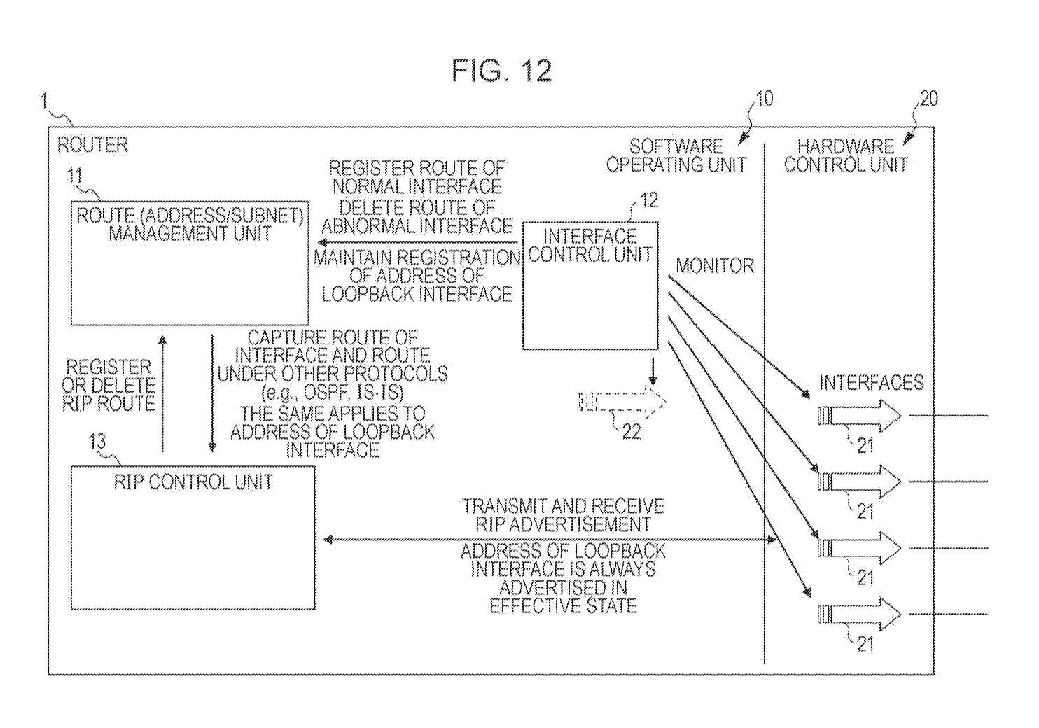

FIG. 12 illustrates a configuration of one example of a router that uses the loopback interface. The router 1 illustrated in FIG. 12 has a configuration similar to that of the router 1 illustrated in FIG. 4. The description below is focused on differences from the router 1 illustrated in FIG. 4.

The interface control unit 12 requests the route management unit 11 to register the route of a normal interface 21 and the route of a loopback interface 22. The interface control unit 12 requests the route management unit 11 to delete an abnormal interface 21. In response to the request, the route management unit 11 registers the route of the normal interface 21 and the route of the loopback interface 22 in the routing table or deletes the route of the abnormal interface 21 from the routing table.

The RIP control unit 13 transmits and receives advertisement of subnet information through the interface 21 using the RIP. The RIP control unit 13 captures the route of the interface 21, the route of the loopback interface 22, and a route under other protocols, such as OSPF or IS-IS, from the route management unit 11 and notifies adjacent routers that the router 1 can communicate with a neighboring device on a subnet connected to the router 1 by advertisement of the subnet information.

It is to be noted that the loopback interface 22 is free from fault and is always in a normal state. Accordingly, the RIP control unit 13 does not publish a deletion advertisement of subnet information for the loopback interface 22.

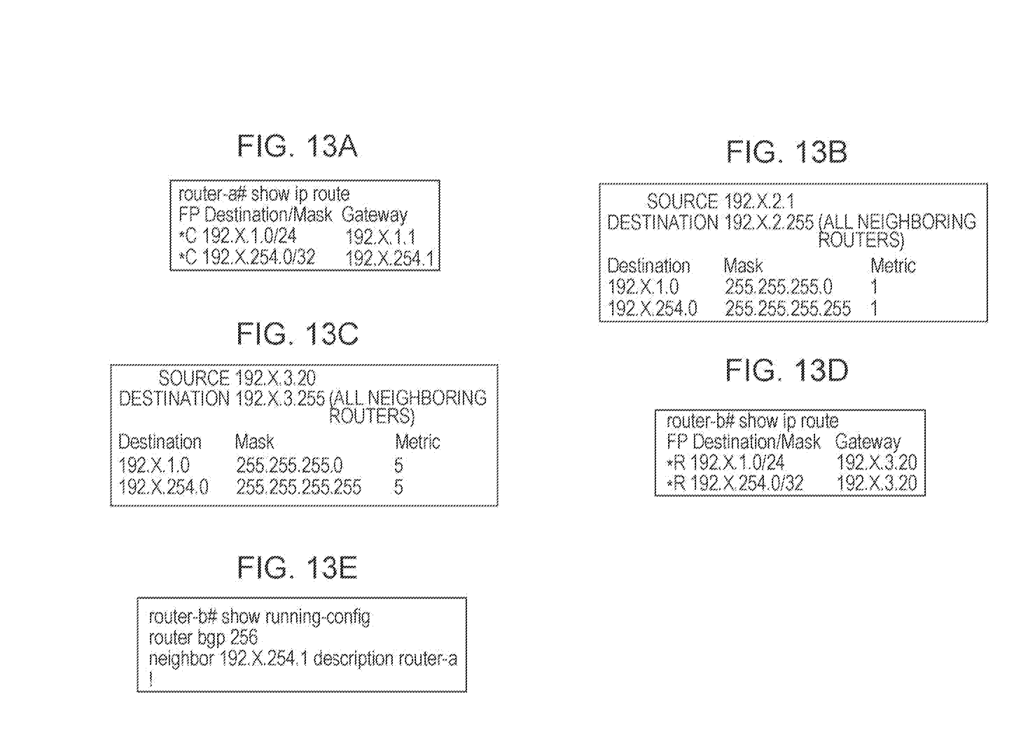

Referring back to the conceptual diagram of FIG. 11, further description is provided. The routing table of the router A during the normal state of the interface 21 having the address “192.X.1.1,” which is a part of the interfaces 21 of the router A, is illustrated in FIG. 13A, an advertisement of subnet information generated by the router A is illustrated in FIG. 13B, an advertisement of subnet information that reaches the router B is illustrated in FIG. 13C, the routing table of the router B is illustrated in FIG. 13D, and the BGP setting of the router B is illustrated in FIG. 13E.

FIG. 13A illustrates the routing table of the router A when the interface 21 having the address “192.X.1.1,” which is a part of the interfaces 21 of the router A, is in a normal state. In the routing table illustrated in FIG. 13A, the subnet having the address “192.X.1.0/24” is visible because the interface 21 having the address “192.X.1.1” is in a normal state. In the routing table illustrated in FIG. 13A, the subnet having the address “192.X.254.0/32,” which is assigned to the loopback interface 22, is also visible.

FIG. 13B illustrates the advertisement of subnet information generated by the router A on the basis of the routing table of FIG. 13A. The advertisement of subnet information illustrated in FIG. 13B is the one for notifying adjacent routers, including the router B, that it can communicate with a neighboring device on the subnets having the addresses “192.X.1.0/24” and “192.X.254.0/32” connected to the router A.

FIG. 13C illustrates the advertisement of subnet information that reaches the router B on the basis of the advertisement illustrated in FIG. 13B. Because the advertisement of subnet information has passed through several routers within a network, the source, destination, and metric in FIG. 13C are changed from those in FIG. 13B.

FIG. 13D illustrates the routing table of the router B based on the advertisement illustrated in FIG. 13C when the advertisement of subnet information published by the router A illustrated in FIG. 13B is propagated to the router B using the RIP. In response to the advertisement of subnet information illustrated in FIG. 13C, the subnet having the address “192.X.1.0/24” and the subnet having the address “192.X.254.0/32” are added in the routing table of the router B.

The BGP setting of the router B illustrated in FIG. 13E indicates the one based on routing information illustrated in FIG. 13D. In the BGP setting illustrated in FIG. 13E, the address “192.X.254.1” of the loopback interface 22 connected to the subnet having the address “192.X.254.0/32” among the plurality of interfaces 21 of the router A is written.

The router B determines that the addition of the subnet having the address “192.X.254.0/32” in the routing table illustrated in FIG. 13D enables information to reach the address “192.X.254.1” and starts BGP communication to attempt to connect to the address “192.X.254.1” of the loopback interface 22 of the router A. After that, the routers A and B are interconnected.

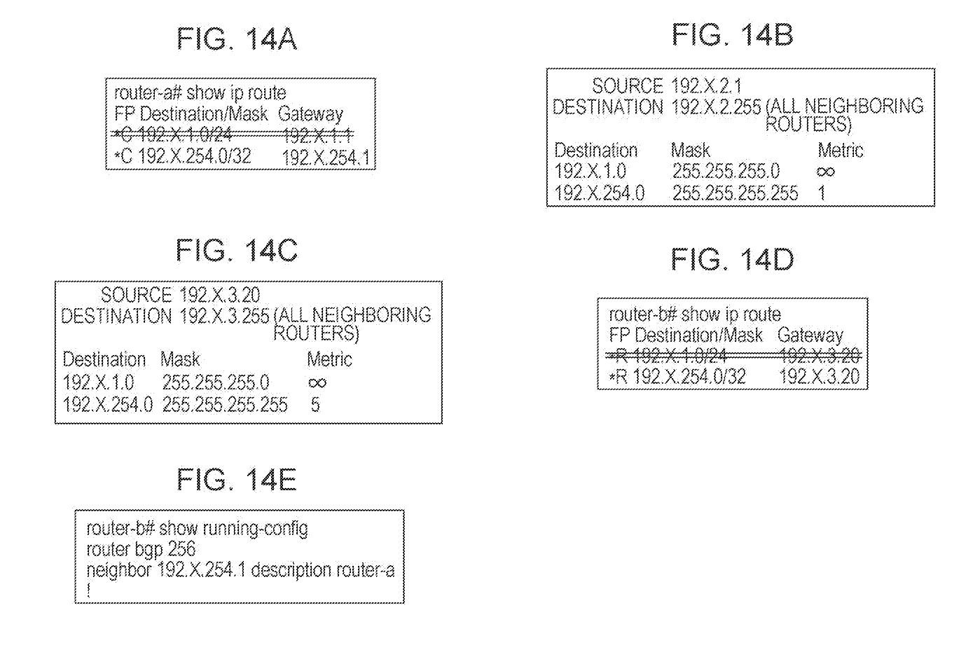

The routing table of the router A when the interface 21 having the address “192.X.1.1,” which is a part of the interfaces 21 of the router A, shifts from a normal state to an abnormal state is illustrated in FIG. 14A, a deletion advertisement of subnet information generated by the router A is illustrated in FIG. 14B, a deletion advertisement of subnet information that reaches the router B is illustrated in FIG. 14C, the routing table of the router B is illustrated in FIG. 14D, and the BGP setting of the router B is illustrated in FIG. 14E.

FIG. 14A illustrates the routing table of the router A when the interface 21 having the address “192.X.1.1,” which is a part of the interfaces 21 of the router A, shifts from a normal state to an abnormal state. In the routing table illustrated in FIG. 14A, because the interface 21 having the address “192.X.1.1” shifts from a normal state to an abnormal state, the subnet having the address “192.X.1.0/24” is invisible. It is to be noted that in the routing table illustrated in FIG. 14A the subnet having the address “192.X.254.0/32,” which is assigned to the loopback interface 22, is visible.

FIG. 14B illustrates the deletion advertisement of subnet information generated by the router A on the basis of a change in the routing table illustrated in FIG. 14A. Specifically, the deletion advertisement of subnet information illustrated in FIG. 14B is generated based on the subnet having the address “192.X.1.0/24,” which was stored in the routing table of FIG. 14A but is made invisible because of the abnormal state. The deletion advertisement of subnet information illustrated in FIG. 14B is the one for notifying adjacent routers, including the router B, that communication with a neighboring device on the subnet having the address “192.X.1.0/24” connected to the router A is disabled.

FIG. 14C illustrates the deletion advertisement of subnet information that reaches the router B on the basis of the deletion advertisement illustrated in FIG. 14B. Because the deletion advertisement of subnet information has passed through several routers within a network, the source, destination, and metric are changed from those in FIG. 14B.

FIG. 14D illustrates the routing table of the router B based on the deletion advertisement illustrated in FIG. 14C when the deletion advertisement of subnet information published by the router A illustrated in FIG. 14B is propagated to the router B. In response to the deletion advertisement of subnet information illustrated in FIG. 14C, the subnet having the address “192.X.1.0/24” is deleted from the routing table of the router B.

The BGP setting of the router B illustrated in FIG. 14E is the same as that illustrated in FIG. 13E. Although the subnet having the address “192.X.1.0/24” is deleted from the routing table illustrated in FIG. 14D, because the subnet having the address “192.X.254.0/32” is not deleted therefrom, the router B determines that information still can reach the address “192.X.254.1” and continues BGP communication. The routers A and B can continue to interconnect with each other.

Upon considering the Background of the instant application, the inventors have pondered consequences of the use of loopback interfaces. For example, the use of loopback interfaces increase the number of interfaces to be managed thereby increasing overall management resources and costs associated with the system. It is to be noted that, when the loopback interface 22 is used, it is necessary to assign a nonexistent subnet by the loopback interface 22 to each of all routers 1 that want to interconnect with another router.

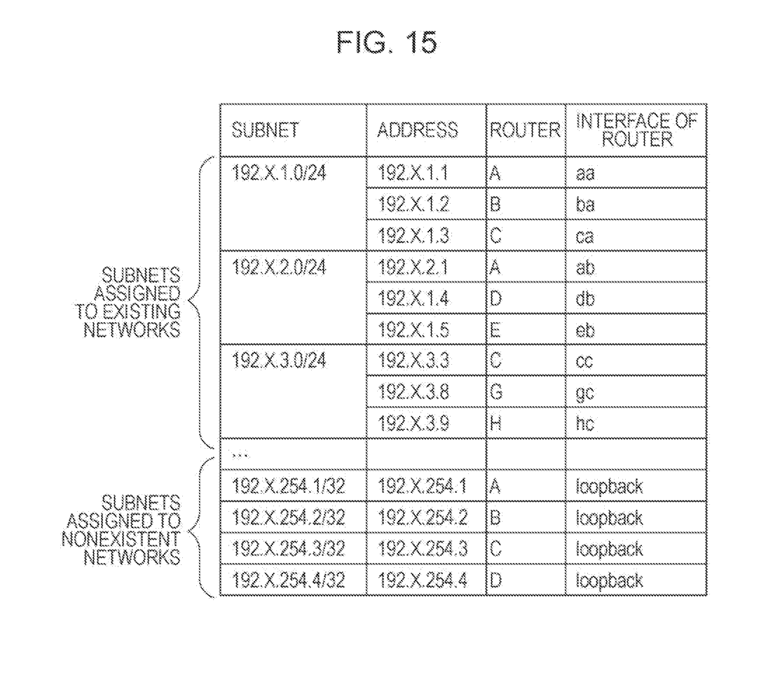

FIG. 15 illustrates one example table for use in managing subnets by a network administrator. The table illustrated in FIG. 15 contains subnets assigned to nonexistent networks, in addition to subnets assigned to existing networks. Accordingly, from the viewpoint of the network administrator, when the loopback interface 22 is used, the number of interfaces to be managed is incremented by one because of the loopback interface 22, so a problem arises in that the load of management is increased.

For example, when the loopback interface 22 is not used, if the interface 21 having the address “192.X.1.1” deviates from a normal state, the router A publishes the deletion advertisement of subnet information to delete the subnet having the address “192.X.1.0/24” from the routing table of the router B.

This deletion advertisement of subnet information causes the address “192.X.1.0/24” to be deleted from the routing table of the router B, so the router B determines that information is disabled from reaching the address “192.X.1.1,” and the interconnection between the routers A and B is disabled.

Incidentally, when the interface 21 having the address “192.X.1.1” deviates from a normal state, information is disabled from reaching a neighboring router on the subnet having the address “192.X.1.0/24” from the router A, so publishing deletion advertisement is appropriate. However, from the viewpoint of the router A, because the address “192.X.1.1” is the router A′s own interface address, this address is still reachable.

In view of the issues identified in the background, one or more embodiments of the present invention, when the interface 21 having the address “192.X.1.1” deviates from a normal state, advertisement of subnet information in which the subnet having the address “192.X.1.0/24” is rewritten into the address “192.X.1.1” of the interface 21 is notified without deletion of the subnet having the address “192.X.1.0/24” using the deletion advertisement.

A router that is notified of the advertisement of subnet information in which the subnet having the address “192.X.1.0/24” is rewritten into the interface 21 having the address “192.X.1.1” can recognize that forwarding information to a neighboring device on the subnet having the address “192.X.1.0/24” is disabled and that forwarding information to the interface 21 having the address “192.X.1.1” of the router A is still allowed.

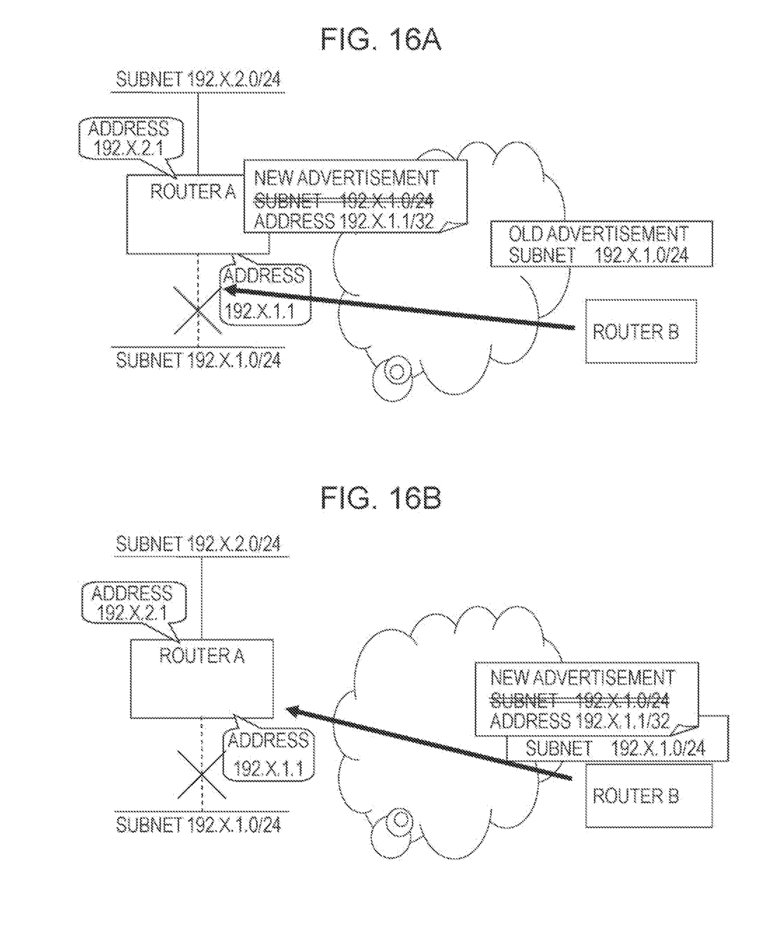

FIGS. 16A and 16B are conceptual diagrams illustrating states where an interface of the router A becomes abnormal after the interconnection between the routers A and B is established according to the present embodiment.

FIG. 16A illustrates a state where the router A publishes an advertisement, hereinafter referred to as a new advertisement, of subnet information, in place of the deletion advertisement of subnet information, because the interface of the router A becomes abnormal and the interconnection between the routers A and B is disabled.

The new advertisement of subnet information is used in place of an old advertisement of subnet information in which the subnet having the address “192.X.1.0/24” is written and is the one in which the subnet having the address “192.X.1.0/24” is rewritten into the interface 21 having the address “192.X.1.1.”

FIG. 16B illustrates a state where the new advertisement published by the router A is propagated to the router B using the RIP. In response to the new advertisement, the router B rewrites the subnet having the address “192.X.1.0/24” into the interface 21 having the address “192.X.1.1.”

Because the subnet of the address “192.X.1.0/24” is deleted from the routing table but the interface 21 having the address “192.X.1.1” is registered, the router B determines that information still can reach the interface 21 having the address “192.X.1.1” and continues BGP communication. The interconnection between the routers A and B can continue.

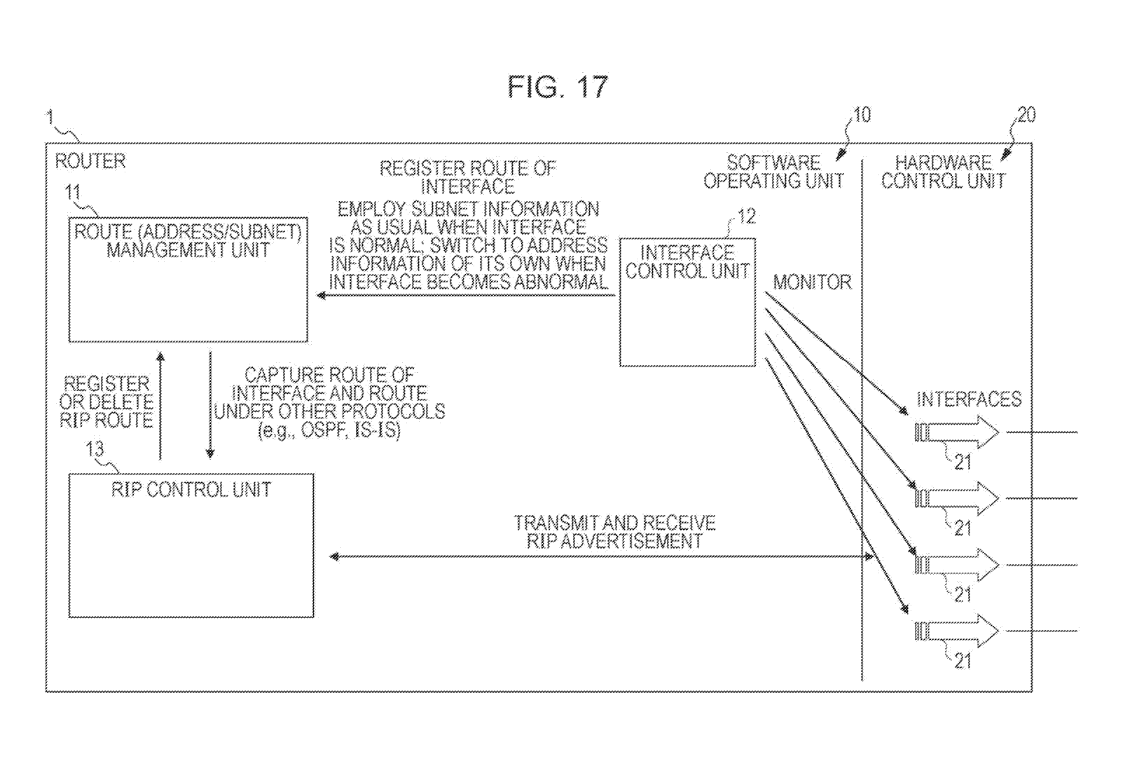

FIG. 17 illustrates a configuration of one example of a router according to the present embodiment. The router 1 illustrated in FIG. 17 has a configuration similar to that illustrated in FIG. 4. The description below is focused on differences from the router 1 illustrated in FIG. 4. The route management unit 11 manages routes using the routing table. The interface control unit 12 monitors normality or abnormality of the interfaces 21 included in the hardware control unit 20.

The interface control unit 12 requests the route management unit 11 to register an address of a subnet as a route of a normal interface 21. When an abnormal interface 21 is present, the interface control unit 12 requests the route management unit 11 to register the address of the abnormal interface 21 as the route of the abnormal interface 21, in place of the address of the subnet.

In response to the request from the interface control unit 12, the route management unit 11 registers the address of the subnet as the route of the normal interface 21 in the routing table and registers the address of the abnormal interface 21 as the route of the abnormal interface 21 in the routing table.

The RIP control unit 13 transmits or receives the new advertisement or the old advertisement of subnet information through the interface 21 using the RIP. The RIP control unit 13 notifies, by the new advertisement or the old advertisement of subnet information, adjacent routers that the router 1 can communicate with a neighboring device on a subnet connected to the router 1, that forwarding information to a neighboring device on the subnet is disabled, or that forwarding information to the interface 21 of router 1 is still allowed.

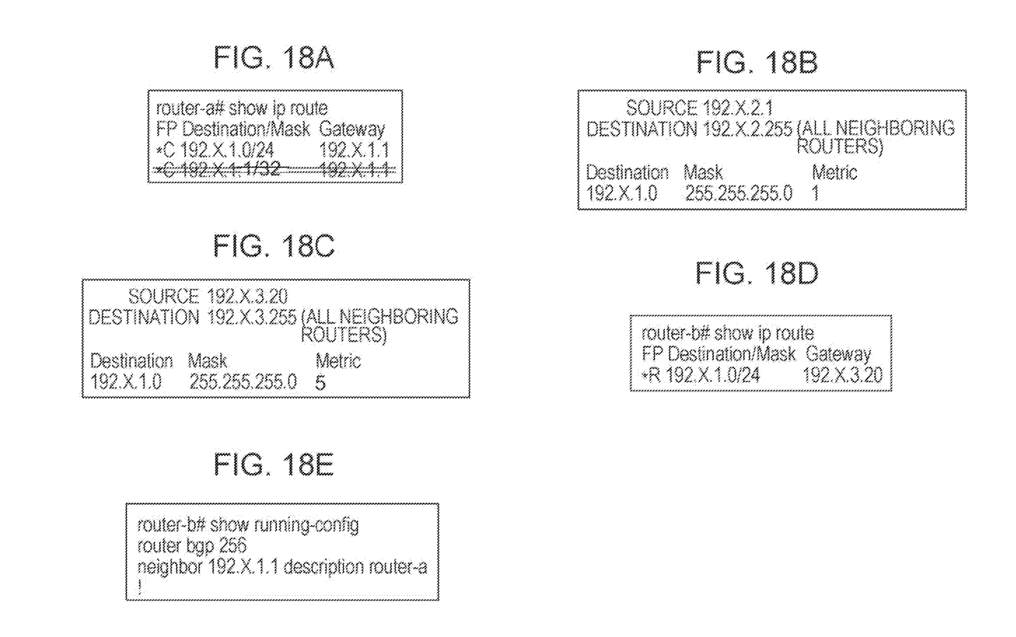

The routing table of the router A during the normal state of the interface 21 having the address “192.X.1.1,” which is a part of the interfaces 21 of the router A, is illustrated in FIG. 18A, an advertisement of subnet information generated by the router A is illustrated in FIG. 18B, an advertisement of subnet information that reaches the router B is illustrated in FIG. 18C, the routing table of the router B is illustrated in FIG. 18D, and the BGP setting of the router B is illustrated in FIG. 18E.

FIG. 18A illustrates the routing table of the router A when the interface 21 of the router A is in a normal state. In the routing table illustrated in FIG. 18A, the subnet having the address “192.X.1.0/24” is visible during the normal state of the interface 21 having the address “192.X.1.1.”

In the routing table illustrated in FIG. 18A, during the normal state of the interface 21 having the address “192.X.1.1”, the interface 21 having the address “192.X.1.1” is made invisible.

FIG. 18B illustrates the advertisement of subnet information generated by the router A on the basis of the routing table of FIG. 18A. The advertisement of subnet information illustrated in FIG. 18B is the one for notifying adjacent routers, including the router B, that the router A can communicate with a neighboring device on the subnet having the address “192.X.1.0/24” connected to the router A.

FIG. 18C illustrates the advertisement of subnet information that reaches the router B on the basis of the advertisement illustrated in FIG. 18B. Because the advertisement of subnet information has passed through several routers within a network, the source, destination, and metric in FIG. 18C are changed from those in FIG. 18B.

FIG. 18D illustrates the routing table of the router B when the advertisement of subnet information published by the router A is propagated to the router B using the RIP. In response to the advertisement of subnet information illustrated in FIG. 18C, the subnet having the address “192.X.1.0/24” is added in the routing table of the router B.

The BGP setting of the router B illustrated in FIG. 18E indicates the one based on routing table in FIG. 18D. In the BGP setting, the address “192.X.1.1” of the interface 21 connected to the subnet having the address “192.X.1.0/32” is written. The router B determines that the addition of the subnet having the address “192.X.1.0/24” in the routing table illustrated in FIG. 18D enables information to reach the address “192.X.1.1” and starts BGP communication to attempt to connect to the address “192.X.1.1” of the interface 21 of the router A. After that, the routers A and B are interconnected.

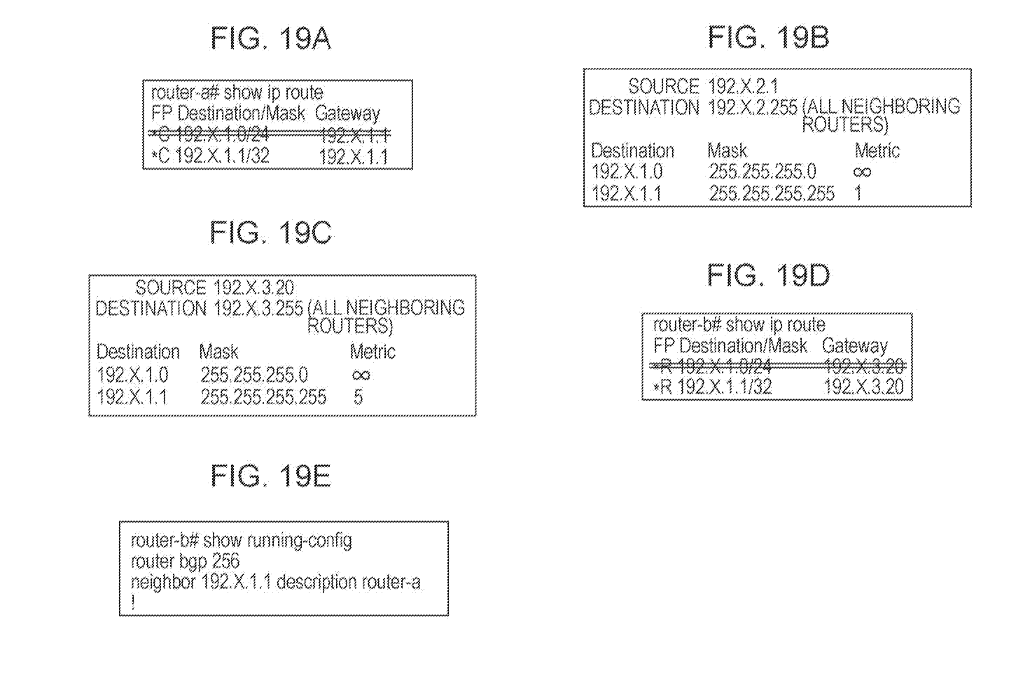

The routing table of the router A when the interface 21 having the address “192.X.1.1” shifts from a normal state to an abnormal state is illustrated in FIG. 19A, the new advertisement of subnet information generated by the router A is illustrated in FIG. 19B, the new advertisement of subnet information that reaches the router B is illustrated in FIG. 19C, the routing table of the router B is illustrated in FIG. 19D, and the BGP setting of the router B is illustrated in FIG. 19E.

FIGS. 19A to 19E are conceptual diagrams illustrating the routing table of the router A when the interface of the router A shifts from a normal state to an abnormal state, the new advertisement of subnet information generated by the router A, the advertisement of subnet information that reaches the router B, the routing table of the router B, and the BGP setting of the router B, respectively.

FIG. 19A illustrates the routing table of the router A when the interface 21 of the router A shifts from a normal state to an abnormal state. In the routing table illustrated in FIG. 19A, because the interface 21 having the address “192.X.1.1” shifts from a normal state to an abnormal state, the subnet having the address “192.X.1.0/24” is invisible. It is to be noted that in the routing table illustrated in FIG. 19A, the address “192.X.1.1/32” of the interface 21 becomes visible instead of subnet address “192.X.1.0/24”.

FIG. 19B illustrates the new advertisement of subnet information generated by the router A on the basis of the routing table illustrated in FIG. 19A. Specifically, the new advertisement of subnet information illustrated in FIG. 19B is generated based on the interface 21 having the address “192.X.1.1,” which is made visible in the routing table of FIG. 19A because of the abnormal state. The new advertisement of subnet information illustrated in FIG. 19B is the one for notifying adjacent routers, including the router B, that communication with a neighboring device on the subnet having the address “192.X.1.0/24” connected to the router A is disabled and that communication with the interface 21 having the address “192.X.1.1” of the router A is still allowed.

FIG. 19C illustrates the new advertisement of subnet information that reaches the router B on the basis of the new advertisement illustrated in FIG. 19B. Because the new advertisement of subnet information has passed through several routers within a network, the source, destination, and metric are changed from those in FIG. 19B.

FIG. 19D illustrates the routing table of the router B based on the new advertisement illustrated in FIG. 19C when the new advertisement of subnet information published by the router A illustrated in FIG. 19B is propagated to the router B. In response to the new advertisement of subnet information illustrated in FIG. 19C, the subnet having the address “192.X.1.0/24” is deleted from the routing table of the router B, whereas the interface 21 having the address “192.X.1.1” is registered therein.

The BGP setting of the router B illustrated in FIG. 19E is the same as that illustrated in FIG. 18E. Although the subnet having the address “192.X.1.0/24” is deleted from the routing table illustrated in FIG. 19D, because the interface 21 having the address “192.X.1.1” is registered therein, the router B determines that information still can reach the address “192.X.1.1” and continues BGP communication. The routers A and B can continue to interconnect with each other.

In such a way, the router 1 according to the present embodiment continues an interconnection with another router even if the interface 21 is not in a normal state. Additionally, it is not necessary for the router 1 to have the loopback interface 22 in order to continue interconnection with another router, the number of subnets to be managed is not increased, and excessive address management is not required. As a result, the load of management on a network administrator is not large as compared with systems in which loopback interfaces are used.

The BGP described in the present embodiment is a protocol used in routing between ISPs, or providers. BGP can be classified into external BGP (eBGP) for exchanging routing control information between neighboring ISPs, or providers, and internal BGP (iBGP) for causing routers that employ eBGP within a site of itself.

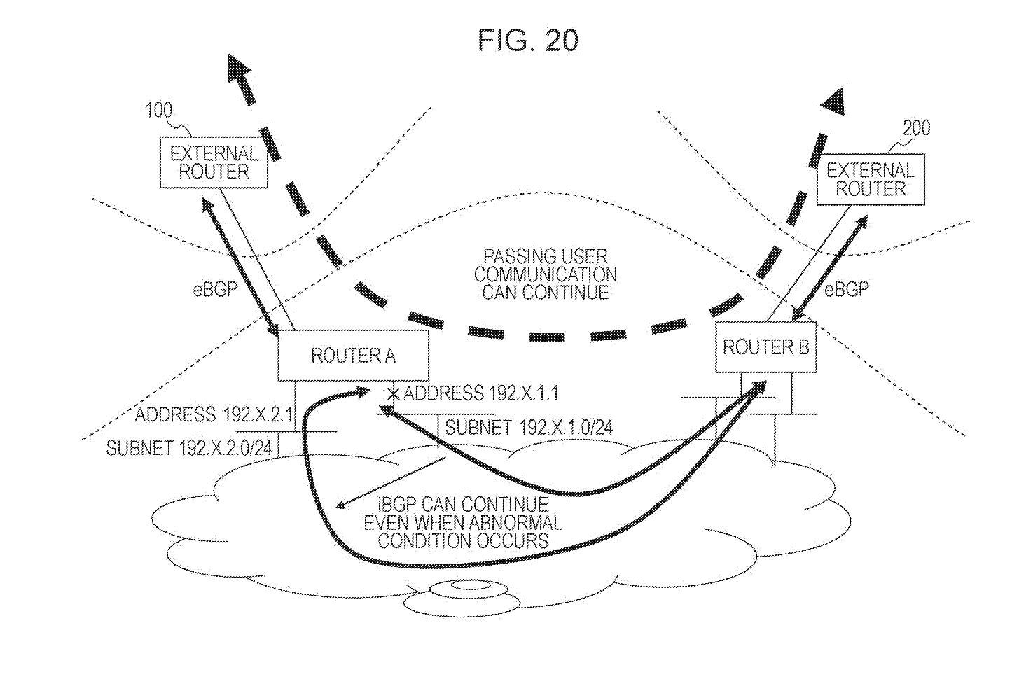

FIG. 20 illustrates a system configuration for use in describing eBGP and iBGP. With iBGP, in order to conduct communication between non-neighboring routers, for example, between an external router 100 and an external router 200, determination whether communication with an iBGP facing router is available or not is made on the basis of an advertisement of subnet information within a site and communication is conducted.

In ordinary operation, routers that employ iBGP, for example, routers A and B introduce a loopback interface and use an additional subnet. However, with the router 1 according to the present embodiment, subnets to which the router 1 is actually connected can be used without such addition.

With the router 1 according to the present embodiment, even if an interface connected to the subnets is not in a normal state, iBGP communication can continue and the number of addresses to be managed may be reduced by not using a loopback interface.

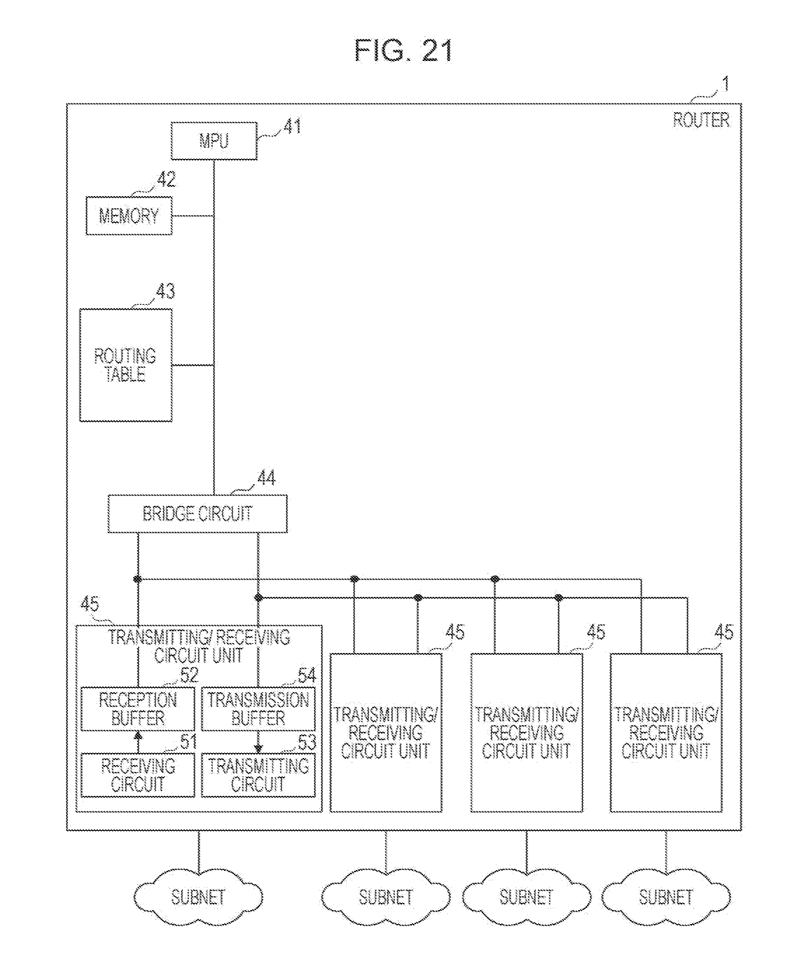

FIG. 21 illustrates a hardware configuration of a router. The router 1 illustrated in FIG. 21 includes a microprocessor unit (MPU) 41, a memory 42, a routing table 43, a bridge circuit 44, and transmitting/receiving circuit units 45.

The MPU 41 is a semiconductor chip that performs basic computation. The MPU 41 reads a program stored in the memory 42, receives data from, for example, any one of the transmitting/receiving circuit units 45 in accordance with instructions of the program, calculates or processes the data in accordance with the program, and sends results of the calculations and processes performed on the dated to the transmitting/receiving circuit unit 45.

The memory 42 is a storage device that stores programs and data. The routing table 43 is a table that is kept by the router 1 and that stores routing information about destinations of network packets (hereinafter referred to simply as packets). The memory 42 and the routing table 43 are considered computer-readable media.

Each of the transmitting/receiving circuit units 45 is a circuit unit for transmitting and receiving data and includes a receiving circuit 51, a reception buffer 52, a transmitting circuit 53, and a transmission buffer 54. The receiving circuit 51 is a circuit for receiving data. The reception buffer 52 is a buffer for temporarily storing data, such as a received packet. The transmitting circuit 53 is a circuit for transmitting data. The transmission buffer 54 is a buffer for temporarily storing data, such as a packet to be transmitted. In FIG. 21, the router 1 has a configuration that includes four transmitting/receiving circuit units 45. However, any number of transmitting/receiving circuit units 45, for example, five or ten, may also be used.

The route management unit 11, the interface control unit 12, and the RIP control unit 13 in the router 1 illustrated in FIGS. 4, 12, and 17 are functional blocks achievable by execution of a program stored in the memory 42, for example. The interfaces 21 in the router 1 illustrated in FIGS. 4, 12, and 17 are functional blocks achievable by the bridge circuit 44 and the transmitting/receiving circuit unit 45, for example.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention

What is claimed is:

1. A routing control device comprising:
a plurality of communication interfaces; and
a processing unit which determines whether each of the plurality of communication interfaces has a fault, sets, in routing control information to perform an advertisement, an address of a communication interface of the plurality of communication interfaces that is determined as having a fault and an address of a subnet connected to a communication interface of the plurality of communication interfaces that is determined as not having a fault.

2. The routing control device according to claim 1, wherein the processing unit performs the advertisement using a protocol that enables the routing control information to be exchanged.

3. A routing control method for use in a routing control device including a plurality of communication interfaces, the routing control method comprising:
determining whether each of the plurality of communication interfaces has a fault;
setting, in routing control information to perform an advertisement using a processing unit, an address of a communication interface of the plurality of communication interfaces that determined as having a fault; and
setting, in the routing control information to perform the advertisement using the processing unit, an address of a subnet connected to a communication interface of the plurality of communication interfaces that is determined as not having a fault.

4. The routing control method according to claim 3, further comprising:
advertising the routing control information using a protocol that enables the routing control information to be exchanged.

5. A computer-readable storage medium with an executable program stored thereon, wherein the program instructs a routing control device including a plurality of communication interfaces to perform a process comprising:
determining whether each of the plurality of communication interfaces has a fault; and
setting, in routing control information by a processing unit, an address of a communication interface of the plurality of communication interfaces that is determined as having a fault; and
setting, in routing control information by a processing unit, an address of a subnet connected to a communication interface of the plurality of communication interfaces that is determined as not having a fault.

6. The computer-readable storage medium with an executable program stored thereon according to claim 5, further comprising:
advertising the routing control information using a protocol that enables the routing control information to be exchanged.

7. The routing control device according to claim 1, wherein the advertisement includes the address of the subnet connected to a communication interface of the plurality of communication interfaces that is determined as not having a fault rather than information of a loopback interface.

8. The routing control method according to claim 3, wherein the advertisement includes the address of the subnet connected to a communication interface of the plurality of communication interfaces that is determined as not having a fault rather than information of a loopback interface.

9. The computer-readable storage medium according to claim 5, wherein the advertisement includes the address of the subnet connected to a communication interface of the plurality of communication interfaces that is determined as not having a fault rather than information of a loopback interface.
